(19) United States
(12) Patent Application Publication
(10) Pub. No.: US 2008/0259620 A1
(43) Pub. Date: Oct. 23, 2008

(54) Light emitting apparatus

(75) Inventors: Tatsuya Oba, Aichi-ken (JP); Akihiro Misawa, Aichi-ken (JP); Tetsuya Arakawa, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 12/078,129

(22) Filed: Mar. 27, 2008

(30) Foreign Application Priority Data
Mar. 28, 2007 (JP) P. 2007-084541

(51) Int. Cl. B60Q 1/00; F21V 7/00

(52) U.S. Cl. 362/487; 362/516

(57) ABSTRACT

A light guide unit which includes a front light emitting surface, a rear surface to which a light reflecting treatment is applied and a side end face which constitutes a light introducing plane and which is formed solid of a light transmissive material as a whole is divided by a vertical slit which reaches the rear reflecting surface.

### BACKGROUND OF THE INVENTION

1. Field of the Invention

The present invention relates to an automotive lamp and more particularly to an improvement in an automotive lamp such as a rear combination lamp.

2. Description of the Related Art

In automotive lamps such as rear combination lamps or high-mount stop lamps, light from a light source is emitted to the outside via an outer lens (a designed cover), so as to obtain a desired light emission. For example, in a rear combination lamp using LED (light emitting diode) lamps, as is shown in FIG. 6, LED lamps 102 are installed inside the outer lens 101, and reflectors 103 are provided on the peripheries of the LED lamps 102, respectively (for example, refer to Patent Document No. 1). In this configuration, light from the LED lamps 102 travels forwards directly or via the reflectors 103, so as to be emitted to the outside through the outer lens 101.

Patent Document No. 1: JP-A-2005-123092

In a rear combination lamp as described above in which LED lamps are used as light sources, apart from a case where LED lamps are preferably made visible in a positive fashion from the viewpoint of design, it is not preferable for LED lamps to become visible from the outside. Because of this, unevenness in luminance is attempted to be reduced by applying a light diffusing treatment (for example, forming extremely thin grooves) to the surface of an outer lens or devising the configuration of a reflector, so that LED lamps are made inconspicuous. However, as long as the LED lamps are disposed inside the outer lens, it is an undeniable fact that the LED lamps are situated on the line of sight of an observer, and therefore, even though the aforesaid countermeasures are devised, it is difficult to conceal totally the existence of the LED lamps.

As a result of every possible effort made by the inventor and others to solve the above problem, an automotive lamp having the following configuration was attained (refer to Japanese Patent Application No. 2006-020592). Namely, it was an automotive lamp including a light guide unit including, in turn, a front light emitting surface, a rear surface having a plurality of reflecting portions which are inclined relative to the front light emitting surface and a side end face, and a light source disposed in a position where the light source faces the side end face, wherein of external light which is incident on the light guide unit via the front light emitting surface, light which travels directly to the side end face is totally reflected on an interface at the side end face portion.

In the configuration described above, of the external light which is incident on the light guide unit via the front light emitting surface, the light which travels directly to the side end face of the light guide unit is totally reflected. The light source is made difficult to be visually recognized through the front light emitting surface of the light guide unit by the total reflection of external light in the way described above. Namely, the light source can be prevented from being directly visually recognized through the front light emitting surface of the light guide unit. In this way, according to the invention, although the configuration is simple, the visual recognition of the light source can effectively be prevented.

The light guide unit itself, which includes the front light emitting surface and the rear reflecting surface, is formed solid and thick. However, since the front light emitting surface takes the form of a convex lens, the rear reflecting surface appears to lie closer to the front light emitting surface than an actual distance therebetween when the rear reflecting surface is observed through the front light emitting surface. Because of this, the depth or thickness that the solid light guide unit actually possesses becomes difficult to be visually claimed.

In addition, an increase in the area of the front light emitting surface results in an increase in the volume of the solid light guide unit increases, and this leads to an increase in load to be borne by the light guide unit in terms of weight and material costs.

### SUMMARY OF THE INVENTION

The invention has been made with a view to solving the problem, and the configuration thereof will be specified into an automotive lamp as follows. Namely, according to a first aspect of the invention, there is provided an automotive lamp including a light guide unit including a front light emitting surface, a rear surface to which a light reflective treatment is applied and a side end face which can constitute a light guiding plane, light guide unit being formed solid of a light transmissive material and a light source disposed to face the side end face, wherein the light guide unit is divided by a vertical slit which reaches from the front light emitting surface to the rear surface.

According to the automotive lamp of the first aspect of the invention which is specified as described above, since the vertical slit is provided in the solid light guide unit, the increase in volume of the light guide unit can be suppressed, whereby a reduction in production cost and weight of the automotive lamp can be attained.

In addition, since the thickness of the light guide unit can be observed through the slit, the observer is allowed to clearly feel the sensation that the light guide unit has a depth or thickness.

### BRIEF DESCRIPTION OF THE DRAWINGS

FIG. 1 is a perspective view of a rear combination lamp 1 which constitutes an embodiment of the invention.

FIG. 2 is a front view of the same.

FIG. 3 is a sectional view of the same, which shows the configuration of a back-up lamp portion 10.

FIG. 4 is a diagram illustrating an angle formed by a front surface 12 and a light incident surface 15a of a light guide unit.

FIG. 5 is a sectional view of another embodiment of the invention, which shows a light guide unit 11a in which a light incident surface 15a is provided as an inclined surface.

FIG. 6 is an example showing the configuration of a conventional rear combination lamp.

### DESCRIPTION OF THE PREFERRED EMBODIMENTS

In an automotive lamp of the invention, light of a light source introduced into a light guide unit is reflected on a reflecting portion on a rear surface of the light guide unit so as to be transformed into light which travels towards a front surface of the light guide unit, whereby the light is allowed to be finally emitted from the front surface of the light guide unit. In this way, in the invention, the front surface of the light guide unit constitutes a light emitting surface, that is, an exterior surface of the lamp. Namely, when the lamp of the invention is seen from the outside, the light emitting surface of the light guide unit is directly observed (not via a cover).

In the automotive lamp of the invention, light from the light source is incident on a side end face of the light guide unit. In this way, the side end face of the light guide unit constitutes a light incident surface. Only part of the side end face may be made to constitute the light incident surface. For example, a portion of the side end face which lies on a rear surface side of the light guide unit is made to constitute a light incident surface. In this case, a surface (a non-light incident surface) is to be provided which connects the light incident surface with the front light emitting surface of the light guide unit. In the event that the light incident surface is configured to be spaced apart from the front light emitting surface, a distance between the front light emitting surface and the rear surface can be adjusted as required, whereby the degree of freedom in designing the light guide unit is enhanced. For example, the areas of the reflecting portion formed on the rear surface and the front light emitting surface can be increased or decreased.

A light reflecting treatment is applied to the rear surface of the light guide unit, whereby a plurality of reflecting portions are formed thereon. In addition, light which travels towards the front light emitting surface is produced by the light reflecting action of the reflecting portions. In order to reduce unevenness in luminance of light emitted from the front light emitting surface, the configuration of the light guide unit is preferably designed in such a manner that the distance between the front light emitting surface and the rear surface of the light guide unit gets shorter continuously or step by step as the surfaces extend further form the side end face. By adopting such a design, an efficiency with which light is taken out is increased in areas of the light guide unit which lie further from the light source, as a result of which light emission can be obtained which includes little luminance unevenness.

The application of the light reflecting treatment on to the rear surface of the light guide unit is implemented by, for example, depositing, plating or spattering a metallic material (aluminum, silver, chrome and the like) or affixing a metallic film to the rear surface. Alternatively, a surface roughening treatment may be applied to the rear surface of the light guide unit or grooves may be formed in a predetermined pattern thereon.

When observing the light guide unit of the lamp of the invention from the outside, the light reflecting surface formed on the rear surface can be seen through the front light emitting surface. Consequently, the light reflecting surface constitutes an important factor which makes up the design of the lamp of the invention. Therefore, an enhancement in the design property of the lamp can be attained by imparting a high design property to the light reflecting surface. For example, depressions are formed continuously in a predetermined pattern on the rear surface of the light guide unit. In the event that the light reflecting treatment is applied to the rear surface in the way described above, a light reflecting surface is configured on which the depressions continue without interruption. Since the configuration of the light reflecting surface depends upon the configuration of the rear surface like this, a light reflecting surface having a desired configuration can easily be formed.

A vertical slit is formed in the light guide unit. The width of this slit is preferably made to be 50 to 10% of a maximum value of the distance between the rear reflecting surface and the front light emitting surface. Here, the distance between the rear reflecting surface and the front light emitting surface is made to be a distance from the front light emitting surface to a portion on the rear reflecting surface where a normal of the front light emitting surface intersects the rear reflecting surface. The maximum value of this distance indicates a thickest portion of the light guide unit. The thickness of the light guide unit can be observed through the slit, the sensation that the observer can feel with respect to the depth or thickness of the light guide unit can be expressed in the form of design. Here, in the event that the width of the slit is less than 10% of the thickest portion of the light guide unit (that is, the maximum value of the distance between the rear reflecting surface and the front light emitting surface), the range of field of view where the width of the light guide unit can directly be observed is restricted to an extreme extent, which is not preferable. On the other hand, in the event that the width of the slit exceeds 50% of the thickest portion of the light guide unit, a sufficient area cannot be obtained on the front light emitting surface, which is not preferable.

Light is also emitted from surfaces of the light guide unit which are provided by providing the slit therein to the outside, whereby a new design property is produced.

The thickest portion of the light guide unit can be made to constitute the side end face which constitutes a light introducing plane, and the thickness of a side of the light guide unit where the side end face lies is in the range of 15 to 50 mm, for example, and preferably in the range of 25 to 40 mm. In the event that this thickness is too small, there is caused a fear that a reduction in light introduction efficiency results or the light guiding action of the light guide unit is badly affected. On the other hand, the thickness concerned is too large, the light guide unit becomes thicker than required, triggering an increase in weight and production costs thereof. The thickness of the other end of the light guide unit is in the range of 3 to 20 mm, for example, and preferably in the range of 5 to 10 mm. The use of the light guide unit which is so thick is effective in preventing the observation of the light source from the outside through the light guide unit.

The number of light sources to be used can be determined in consideration of the size of a light guide unit to be used or a required luminance of light emitted from the lamp.

Since the light guide unit is divided by the slit, a light source is disposed for each of pieces of the light guide unit so divided. The colors of light emitted from the light sources so disposed can be differentiated piece by piece.

In order to secure a sufficient quantity of light for the light source, a plurality of light sources are normally used. These light sources are arranged in a row along the side end face of the light guide unit.

There is imposed no specific limitation on types of light sources, and hence, LED lamps, bulbs and the like can be used. It is preferable to adopt LED lamps among them. This is because a reduction in size of a decoration unit can be attained due to LED lamps being small in size. In addition, LED lamps are advantageous in that the heat value thereof is so small that members surrounding LED lamps are little affected thermally by them. Furthermore, LED lamps are also advantageous in that they need little driving power and have a long service life. There is no specific limitation on types of LED lamps, and hence, various types of LED lamps can be adopted which includes Led lamps of a shell type, a chip type and the like. However, it is particularly preferable to adopt LED lamps with a lens which have high directivity.

Colors can arbitrarily be selected for light sources. A plurality of light sources can also be used to be controlled so as to change the color of light to be emitted.

### Embodiment 1

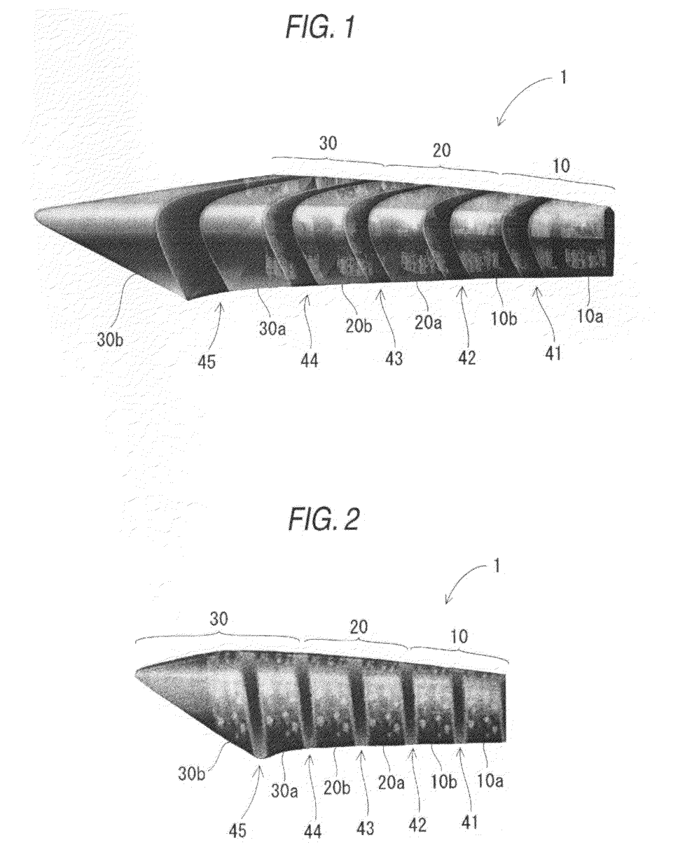

Hereinafter, the configuration of the invention will be described in greater detail using an embodiment. FIG. 1 is a perspective view showing a rear combination lamp 1 which constitutes an embodiment of the invention. The rear combination 1 is made up of a back-up lamp portion 10 which is illuminated as a back-up lamp, a tail lamp/stop lamp portion 20 which is illuminated as a tail lamp/stop lamp and a direction indicator lamp portion 30 which is illuminated as a direction indicator lamp.

The back-up lamp portion 10 includes two pieces 10a and 10b, and a first slit 41 is formed therebetween. The tail lamp/stop lamp portion 20 includes two pieces 20a and 20b, and a third slid 43 is formed therebetween. The direction indicator lamp portion 30 includes two pieces 30a and 30b, and a fifth slit 45 is formed therebetween. A second slit 42 is formed between the back-up lamp portion 10 and the tail lamp/stop lamp portion 20, and a fourth slit 44 is formed between the tail lamp/stop lamp portion 20 and the direction indicator lamp portion 30.

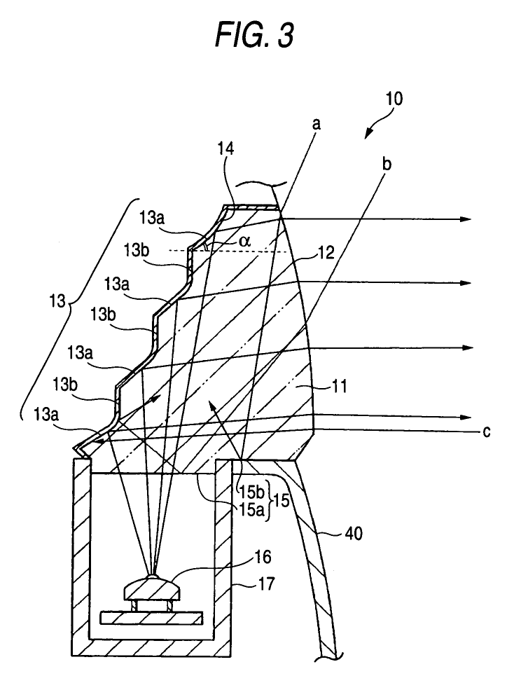

As is shown in FIG. 3, which is a sectional view of FIG. 1, a light guide unit 11 made of an acrylic resin having a refractive index of about 1.5 and an LED lamp 16, which is to be disposed below the light guide unit 11, are provided in the back-up lamp portion 10. The light guide unit 11 has a substantially triangular cross sectional shape. A front surface (a light emitting surface) 12 of the light guide unit 11 is made up of a convexly curved surface which is curved moderately. The radius of curvature of the convexly curved surface is in the range of 400 to 600 mm. On the other hand, a rear surface 13 of the light guide unit 11 is molded into a regular stepped configuration. Specifically, in an interface at the rear surface 13 of the light guide unit 11, a reflecting portion 13a which is inclined relative to the front surface 12 and a non-reflecting portion 13b which connects together two such reflecting portions 13a which are adjacent to each other are provided to continue alternately, whereby the thickness of the light guide unit 11 is reduced from one end to the other end thereof. As to specific thickness (distances between the front and rear surfaces) of the light guide unit, the light guide unit is about 30 mm thick at its thickest portion and about 10 mm thick at its thinnest portion. Incidentally, the light guide unit 11 is about 40 mm high.

A light reflecting layer 14 is formed by depositing an aluminum material over the whole of the rear surface 13 of the light guide unit 11. Light is reflected efficiently by this light reflecting layer 14. In addition, this light reflecting surface 14 becomes visible from the outside when the LED lamp 16 is turned off, whereby the observer feels the sensation that the back-up lamp portion 10 is made of metal.

In this embodiment, the reflecting portion 13a constitutes a convexly curved surface (a reflecting surface) which is inclined at a predetermined angle relative to a light incident surface 15a, which will be described later. In section, an angle formed by the convexly curved surface and the light incident surface 15a is about 40 to 50° (refer to FIG. 3). On the other hand, the surface of the non-reflecting portion 13b becomes substantially vertical relative to the light incident surface 15a in section. The configurations and angles of the reflecting portion 13a and the non-reflecting portion 13b are set in consideration of the light distribution property of the back-up lamp portion 10. In addition, light from the LED lamp 16, which will be described later, is configured to be shone on to all the reflecting portions 13a. Additionally, the configurations and angles of all the reflecting portions 13a do not have to be the same. This is true with the non-reflecting portions 13b.

A side end face 15 which connects the front surface 12 and the rear surface 13 of the light guide unit 11 together at a lower portion shown as is shown in the figure is divided into two areas, that is, the light incident surface 15a and a non-light incident surface 15b by a difference in level formed in the vicinity of a substantially central portion of the side end face 15. The LED lamp 16 is disposed in such a manner as to face the light incident surface 15a. The distance between the front surface 12 and the rear surface 13 can be adjusted as required by adopting the configuration like this in which the light incident surface 15a and the front surface 12 are spaced apart from each other. Namely, the degree of freedom in designing the light guide unit 11 is increased.

On the other hand, the LED lamp 16 is disposed below the light guide unit 11, so as to a longitudinal thickness of the back-up lamp portion 10 is reduced, whereby an increase in design property can be attained.

The LED lamp adopted in this embodiment has a small heat value as well as a small consumed power. In addition, the LED lamp has strong resistance to vibration and impact and hence has a long service life. Furthermore, the LED lamp is so small in size that a small space only has to be provided for installation thereof as a light source, thereby making it possible to attain a reduction in size and weight of the rear combination lamp. Turning on and off the LED lamp 16 is controlled by a known control circuit (not shown). Reference numeral 17 denotes a housing for the LED lamp 16. The housing is formed of, for example, a synthetic resin. In addition, the housing 17 is fixed and positioned by making use of the different in level formed on the side end face 15 of the light guide unit 11.

In the back-up lamp portion 10 that is configured as has been described heretofore, when the LED lamp 16 is illuminated in response to an input signal from the vehicle side, the following light emitting mode will be realized. Firstly, light emitted from the LED lamp 16 is incident on the light incident surface 15a of the light guide unit 11, so as to be taken into the light guide unit 11. Then, the light is reflected on the reflecting portions 13a formed on the rear surface 13 of the light guide unit 11, so as to produce light which travels towards the front surface 12 of the light guide unit 11. The light produced in this way is emitted from the front surface 12 of the light guide unit 11, whereby a predetermined indication is effected by the light so emitted.

Here, although the quantity of light reaching the light reflecting portions 13a is reduced in the area which lies further from the LED lamp 16, the efficiency with which light is taken out in the area where the quantity of reaching light becomes insufficient is increased by configuring the light guide unit to reduce its thickness step by step according to the distance from the LED lamp 16, whereby the luminance of light emitted becomes even. In addition, the luminance of light emitted is also made even by the configuration in which the light from the LED lamp 16 is shone on to all the reflecting portions 13a.

On the other hand, in the back-up lamp portion 10, no light source is disposed on the rear surface 13 side of the light guide unit 11 (but the light source is disposed in the position where the light source faces the light incident surface 15a of the light guide unit), and the very thick light guide unit as has been described above is used which is designed such that of external light which is incident on the front surface 12, external light which travels directly towards the light incident surface 15a is totally reflected by an interface at the light incident surface 15a, whereby the direct observation of the LED lamp 16 from the outside through the light guide unit is prevented.

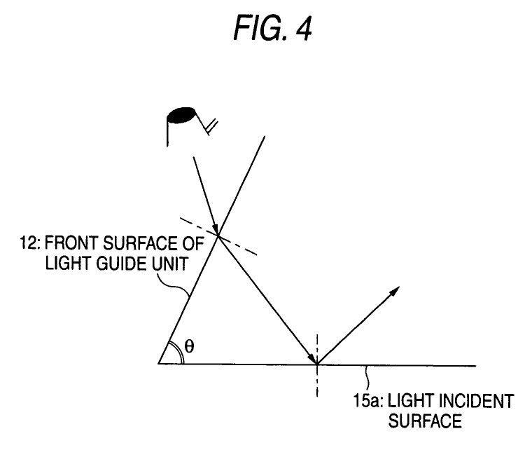

When observing the back-up lamp portion from a position a or position b, the LED lamp 16 is not visually recognized due to the total reflection of light on the front surface 12 and the light incident surface 15a of the light guide unit. When observing the back-up lamp portion from a position c, the light reflecting layer 14 becomes visible, but the existence of the LED lamp 16 becomes unaware as when observing the back-up lamp portion is observed from the position a and or the position b. In order to make the total reflection referred to herein happen, as is shown in FIG. 4, letting the refraction index of the light guide unit be n, an angle θ that is formed by the front surface 12 and the light incident surface 15a of the light guide unit needs to satisfy a predetermined condition, that is, the following relation (on condition that the light incident surface 15a is a flat plane).

θ>2 sin⁻¹ (1/n) [Expression 1]

In the event that the light guide unit 11 is designed so as to satisfy the condition described above over the whole of the front surface 12 of the light guide unit 11, irrespective of the position of a point of view, the LED lamp 16 becomes invisible when the direction of the LED lamp 16 (that is, the direction of the light incident surface 15a) is viewed through the front surface 12 of the light guide unit 11. Namely, the direct visual recognition of the LED lamp 16 through the front surface 12 of the light guide unit 11 becomes impossible. Although the existence of the LED lamp 16 is concealed totally in this way, in consideration of the fact that the range of the point of view of the observer when the rear combination lamp 1 is used is limited (for example, in a normal use, the rear combination lamp 1 is observed in no case from the position a in FIG. 3), there will be caused no practical problem even if the aforesaid condition is not satisfied at part (for example, an edge portion) of the front surface 12 of the light guide unit 11. Then, the angle θ that is formed by the light guide unit front surface 12 and the light incident surface 15a may be configured to satisfy a predetermined condition, that is, the following relation.

θ>2 sin⁻¹ (1/n)−10° [Expression 2]

An area through which the LED lamp 16 can directly be viewed from the outside may be formed on the front surface 12 of the light guide unit 11 in a positive fashion. According to the configuration, an unexpected effect can be produced in which the LED lamp 16 suddenly becomes visible or the LED lamp 16 which has been visible suddenly disappears from the field of view as the position of a point of view changes.

Incidentally, the light incident surface 15a is preferably made into a smooth plane with a view to facilitating the occurrence of total reflection. With the light incident surface 15a made into a smooth plane, light from the LED lamp 16 can be taken into the interior of the light guide unit with good efficiency, and furthermore, directions in which the light so taken into travels can be aligned. In this way, forming the light incident surface 15a into the smooth plane is preferable from the viewpoint of light utilization efficiency and light distribution control.

In this embodiment, a good distribution of light taken into the light guide unit 11 is realized by making the light incident surface 15a into the smooth plane. In addition, the configuration of the light incident surface 15a is not limited to the flat plane and hence, the light incident surface 15a may be configured to be made up of an arbitrary curved surface, for example. In addition, the light incident surface 15a may be made up of a combination of differently configured surfaces.

As has been described heretofore, in the back-up lamp portion 10, the light source (the LED lamp 16) is kept invisible from the out side, and moreover, light which has little luminance unevenness can be obtained, thereby a superior design property being provided. Since the front surface (the light emitting surface ) 12 of the light guide unit 11 is made up of the convexly curved surface which is curved moderately, the rear surface 13 thereof is molded into the regular step-like configuration and the slit 41 is formed therein, the emission of light can be verified even when the back-up lamp portion 10 is viewed directly from the side thereof.

Furthermore, since the first slit 41 is formed in the back-up lamp portion 10, the thickness of the light guide unit 11 which makes up the back-up lamp portion 10 can directly be observed. Due to this, the sensation felt by the observer that the solid light guide unit has a thickness or depth can be expressed in the form of design.

The volume of the light guide unit can be reduced by providing the slit effectively, whereby a reduction in weight and production costs of the lamp can be attained.

The tail lamp/stop lamp portion 20 and the direction indicator lamp portion 30 have the same construction as that of the back-up lamp portion 10. Light sources of colors required for the respective lamp portions are disposed.

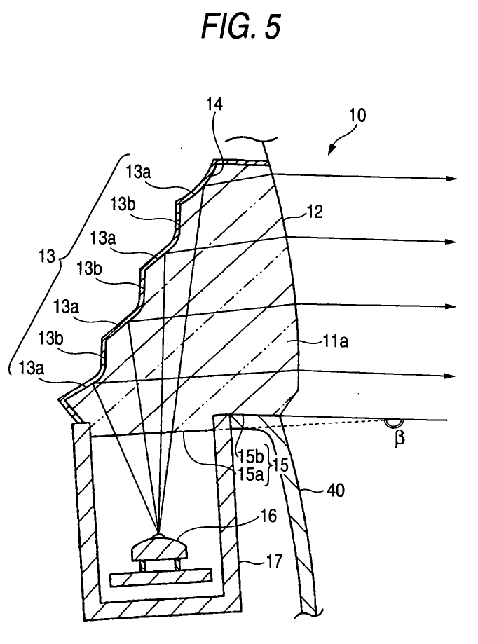

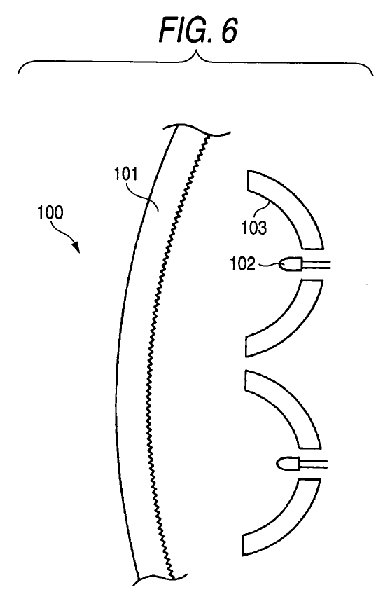

In this embodiment, while the light incident surface 15a and the non-light incident surface 15b of the light guide unit 11 are formed in the parallel relationship, the light incident surface 15a can be configured to be inclined relative to the non-light incident surface 15b as is shown in FIG. 5. In an example shown in FIG. 5, a light incident surface 15a is inclined in a direction in which an angle formed by the light incident surface 15a and a non-light incident surface 15b is reduced. An angle β that is formed by the two surfaces is about 160°. The configuration like this is effective in preventing an LED lamp 16 from being observed directly via a front surface 12 of the light guide unit. Namely, by inclining the light incident surface 15a, an area through which the LED lamp 16 is kept invisible can be expanded, whereby the degree of freedom in designing the front surface 12 of the light guide unit 11, thereby making it possible to reduce the thickness of the light guide unit 11. In addition, inclining the light incident surface 15 is effective in increasing the number and area of reflecting portions 13a. The increase in the area of reflecting portions contributes to making the light luminance even. In addition, although there is imposed no specific limitation on the angle formed by the light incident surface 15a and the non-light incident surface 15b, the angle concerned is in the range of 120 to 180°, for example.

In the embodiment that has been described heretofore, while light is described as being introduced into the light guide unit therebelow, the invention is not limited thereto, and hence, a configuration may be adopted in which light is introduced into the light guide unit from thereabove or the side thereof.

In addition, the configuration of the rear surface of the light guide unit and the thickness of the light guide unit are only examples, and hence, these can arbitrarily be designed or set as long as the advantages are provided that the light source is made difficult to be visually recognized from the outside and the highly designed light emitting mode is obtained. There is imposed no specific limitation on the material of the light guide unit, and hence, light guide units can be adopted which are made of light guiding materials having a refraction index of the order of 1.4 to 1.8. Specifically, in addition to the acrylic resin used in this embodiment, a polycarbonate resin, an epoxy resin, glass and the like can be adopted.

In addition, while the pieces which make up the respective lamp portions are described as being independent, those pieces may be made to continue without interruptions. Namely, the light guide unit is made into a single piece which continues without interruptions on the back reflecting surface, so that respective pieces are provided in such a manner as to erect therefrom, whereby the number of components is reduced, and the assembly of components involved becomes easy and simple.

The invention is applied to lamps of various types of vehicles (passenger cars, buses, trucks and the like). Specifically, the invention can be applied to rear combination lamps, tail lamps, stop lamps, high-mount stop lamps, headlamps, fog lamps and the like.

The invention is not limited to the mode of the embodiment and the description thereof in any way. Modes are included in the scope of the invention which can be modified variously without departing from the spirit and scope of the invention including claims thereof and within a scope which could easily be attained by those skilled in the art to which the invention pertains.

All the contents of the articles, unexamined and examined patent publications and the like are to be incorporated herein by reference.

What is claimed is:

1. An automotive lamp, comprising:
a light guide unit comprising a front light emitting surface, a rear surface to which a light reflective treatment is applied and a side end face which constitutes a light guiding plane, the light guide unit being formed solid of a light transmissive material; and
a light source disposed to face the side end face;
wherein the light guide unit is divided by a vertical slit which reaches from the front light emitting surface to the rear surface.

2. The automotive lamp as set forth in claim 1, wherein the slit is 50 to 10% of a maximum value of a distance between the reflection surface and the front light emitting surface.

3. The automotive lamp as set forth in claim 1, wherein the front light emitting surface is a convexly curved surface.

4. The automotive lamp as set forth in claim 1, wherein the rear surface is a regular stepped configuration.

5. The automotive lamp as set forth in claim 4, wherein the rear surface is comprised of a reflecting portion inclined relative to the front light emitting surface and a non-reflecting portion which connects the reflecting portion that are adjacent to each other; and the reflection portion and the non-reflecting portion are provided to continue alternately.
